(19) United States
(12) Patent Application Publication
(10) Pub. No.: US 2010/0321233 A1
(43) Pub. Date: Dec. 23, 2010

(54) METHOD FOR CALIBRATING ANTENNA ARRAYS

(75) Inventors: Avra'am Ben-Zur, Ra'anana (IL); Michael Delishansky, Netanya (IL); David Shechter, Kfar Yona (IL)

Correspondence Address: BROWDY AND NEIMARK, P.L.L.C.;624 NINTH STREET, NW, SUITE 300, WASHINGTON, DC, 20001-5303, US

(73) Assignee: ALVARION LTD., Tel-Aviv (IL)

(21) Appl. No.: 12/486,905

(22) Filed: Jun. 18, 2009

(51) Int. Cl. G01S 7/40

(52) U.S. Cl. 342/174

(57) ABSTRACT

A method is provided for use in calibrating a plurality of antennas comprised in an antenna array and wherein the antenna array comprises at least one gain control circuitry. The method comprises: transmitting one or more pre-defined signals by at least one antenna comprised in the antenna array; receiving at one or more of the antennas comprised in the antenna array, a signal derived from a corresponding pre-defined signal transmitted by the at least one antenna; and for each of the one or more antennas, detecting whether there is any difference between the corresponding one or more pre-defined signals transmitted thereto and the respective one or more signals received thereat, and if in the affirmative, applying the detected differences in a process of calibrating the one or more antennas comprised in the antenna array, and wherein the process of calibrating the one or more antennas comprised in the antenna array comprises a step of estimating a ratio of complex transmission coefficients for at least two states of the at least one gain control circuitry.

### FIELD OF THE INVENTION

The present invention relates to a method for self testing antenna arrays in wireless systems. In particularly the present invention relates to the calibration of antenna arrays in such systems.

### BACKGROUND OF THE INVENTION

Exchange of communications between a subscriber device and a base station which comprises an adaptive antenna array, is carried out by transmitting communications from the base station towards the subscriber device using a beam generated by the base station and directed towards the subscriber device (referred to herein as “beam-forming” or “BF”). In order to ensure successful transmission and reception of communications to/from the subscriber, the base station must ensure that the antenna array used is properly calibrated. Typically, this type of operation, i.e. checking the antenna array calibration, is carried out every second up to about a minute time interval.

The BF is especially effective in TDD systems because the same frequency is used for both transmission and reception. Using the same carrier frequency for uplink and downlink means that the channel is the same on both directions, and the base station can make use of the downlink channel information derived from uplink channel estimates. Calculating downlink (“DL”) weights from uplink (“UL) signals assumes reciprocity in the channel, but such reciprocity does not exist for the BS receiver/transmitter hardware. Therefore, one would need to calibrate this non-reciprocal part, more specifically, the radio hardware. In fact, it would be necessary to compensate for the amplitude and phase errors existing between the radio channels due to differences in the RF devices due to tolerances and depend upon operating frequencies. Since these errors also change over time, mainly due to temperature variations, it is essential to have real-time dynamic calibration.

The prior art solutions that are currently used to overcome such problems, rely on either an external calibration unit as shown in FIG. 1 or makes use of a self-calibration mechanism as shown in FIG. 2.

An example of the external calibration scheme is illustrated in U.S. Pat. No. 6,195,045. The disadvantage of applying the scheme disclosed by this publication is that it requires additional radio unit with TX/RX calibration channels and additional control mechanisms to control and synchronize the calibration transmissions together with the regular modem transmissions. In addition, it requires also an external circuitry to link the channels with the calibration unit (e.g. couplers and combiners have to be incorporated into the antenna array design). The external circuitry can be simplified if antennas of the array are placed relatively near each other so that the calibration unit (equipped with antenna) can transmit to/receive from the other antennas of that array using the air as the transmission media. However, the limitation of this approach is the large dynamic range required from the RX channels since the isolation between antennas can vary extensively. For example, the array of 2 antennas built in the same panel has isolation in the range of from 30 dB to 60 dB, depending on the operating frequency and polarization, but for two antennas separated by several wave lengths to enable space diversity, the isolation can reach up to 90 dB. Self-calibration schemes as exemplified in EP 1503518 are based on the use of one or more of the TX/RX channels for the purpose of self-calibration. Specifically, during the TX calibration, all the TX channels transmit the calibration signal while one or more of the RX channels are dedicated to receive it. Thereafter, at the RX stage of the calibration, all the RX channels would receive the calibration signal while one or more of the TX channels are dedicated to transmit the calibration signal. The disadvantage of this method is that it uses a lot of additional components for the calibration, such as switches to route the signal, couplers and combiners. Furthermore, this method requires special radio hardware design and cannot be used on the basis of the existing design.

U.S. Pat. No. 6,037,895 describes a method for calibrating a communications station that includes an antenna array of antenna elements, each having associated with it and included in a transmit apparatus chain and a receiver apparatus chain. The method comprises transmitting in series, a prescribed signal from each antenna element using the transmit apparatus chain associated with the antenna element while receiving the transmitted signal in receiver apparatus chains not associated with the antenna. Calibration factors for each antenna element are determined as dependent on the associated transmit apparatus chain and receiver apparatus chain transfer functions using the prescribed signal and each of the signals received during transmissions.

KR 2001090138 describes a receiving path calibration method for controlling the power of a wireless base station to exactly determine an AGC control voltage value for an actual receiving input level of a base station, by carrying out calibration for an AFEU (Antenna Front-End Unit). By this method, a Base station Test Unit) generates a single tone signal and inputs it to an AFEU. The AFEU filters the single tone signal using a filter and executes low noise amplification for the signal through a Low Noise Amplifier). A transceiver carries out frequency-down conversion for the output signal of the AFEU, variably attenuates the signal using a variable attenuator, splits it into an I signal and a Q signal, and outputs them. The output signals of the transceiver are demodulated and a variable attenuatoion control voltage value is determined for a variable attenuator in the transceiver according to the power level. The determined value is then transferred to the variable attenuator in the transceiver.

### SUMMARY OF THE INVENTION

It is an object of the present invention to provide a method that will allow implementing self testing and calibration of antenna array while still using existing standard radio hardware architecture without adding dedicated channels and/or extra physical attenuators/switches and/or complicated external circuitry for coupling TX/RX channels.

It is another object of the present invention to provide a method that enables higher self testing and calibration accuracy and lower loss of bandwidth consumed by the self testing/calibration process.

It is yet another object of the present invention to provide a method that allows fast calibration of the radio resources, without being required to add complicated external calibration unit.

Other objects of the invention will become apparent as the description of the invention proceeds.

Thus, according to a first embodiment of the present invention there is provided a method for use in calibrating one or more antennas comprised in an antenna array, which comprises:
transmitting one or more pre-defined signals by at least one antenna comprised in said antenna array;
receiving at one or more of the antennas comprised in the antenna array, a signal derived from a corresponding pre-defined signal transmitted by the at least one antenna; and
for each of the one or more antennas, detecting whether there is any difference between the corresponding one or more pre-defined signals transmitted thereto and the respective one or more signals received thereat, and if in the affirmative, applying the detected differences in a process of calibrating said one or more antennas comprised in the antenna array.

According to a preferred embodiment of the present invention a method is provided for use in calibrating a plurality of antennas comprised in an antenna array and wherein the antenna array comprises at least one gain control circuitry. The method comprises:
transmitting one or more pre-defined signals by at least one antenna comprised in the antenna array;
receiving at one or more of the antennas comprised in the antenna array, a signal derived from a corresponding pre-defined signal transmitted by the at least one antenna; and
for each of the one or more antennas, detecting whether there is any difference between the corresponding one or more pre-defined signals transmitted thereto and the respective one or more signals received thereat, and if in the affirmative, applying the detected differences in a process of calibrating the one or more antennas comprised in the antenna array, and wherein the process of calibrating the one or more antennas comprised in the antenna array comprises a step of estimating a ratio of complex transmission coefficients for at least two states of said at least one gain control circuitry.

The term “gain control circuitry” as used herein and through the specification and claims should be understood to encompass a device/circuitry such as switched attenuators, switched gain amplifiers, on/off amplifiers, voltage controlled amplifiers/attenuators e.g. with discrete applied voltages, and the like.

The term “complex transmission coefficients” as used herein and through the specification and claims should be understood to encompass complex gain and/or complex coefficients, for both gain/attenuation and phase.

According to an embodiment of the invention, the method provided further comprising a step of selecting an antenna from among the plurality of antennas comprised in the antenna array for transmitting the one or more pre-defined signals which would enable achieving improved overall calibration of said antenna array.

In accordance with another embodiment of the invention, the process of calibrating the one or more antennas comprised in the antenna array is a dynamic process, preferably a process that is adapted to be carried out at the antenna array installation site.

By another embodiment of the invention, the method provided further comprises a step of determining whether any of the pre-defined signals and/or their corresponding received signals should be conveyed along a path extending between at least two antennas comprised in said antenna array via a cable.

In the process of calibrating the antenna array one of the antennas is referred to as an “anchor antenna”, and in the process which is referred to herein as “RX calibration”, a pre-defined signal is transmitted towards at least one antenna comprised in the antenna array, receiving a signal derived from that pre-defined signal by the at least one antenna and estimating the effect of using the RX channel of each of the at least one antenna, based on one or more differences detected between the pre-defined signal and the signal received by each of the at least one antenna.

The step of selecting the anchor antenna from among the plurality of antennas comprised in the antenna array in order to achieve improved overall calibration quality of the antenna arrays is based on evaluating the set of receiving signals derived from the pre-defined transmitted signals. Preferably, the evaluation of the set of receiving signals is based upon the collective signals quality in terms of, for example, signal level at antenna port, signal to noise ratio (SNR), signal to noise and interference ratio (SINR), and the like. Preferably, a pre-defined signal is transmitted by the first antenna towards each of the antennas that are members of the antenna array in order to calibrate all RX channels comprised in the array.

According to another preferred embodiment of the present invention the method provided is used in calibrating TX channels of one or more of the antennas comprised in the antenna array. The TX calibration is accomplished by transmitting a pre-defined signal by at least one antenna comprised in that antenna array, receiving by a first antenna a signal that is derived from the pre-defined signal, and estimating the effect obtained while using the TX channel of each of the at least one antenna based on one or more differences detected between the signal transmitted by each of the at least one other antenna and the signal derived therefrom and received by the first antenna.

Preferably, each of the antennas that are members of the antenna array will transmit such a pre-defined signal in order to calibrate all the TX channels comprised in the array.

According to yet another embodiment of the invention the method provided further comprises a step of selecting the first antenna (i.e. the anchor antenna) from among the plurality of antennas comprised in the antenna array. Preferably, the selection of the first antenna is made to achieve best overall calibration of the antenna array. The freedom to decide which of the antennas will be used as the anchor one, is due the fact that no special hardware distinguishes the anchor antenna from among the remaining antennas of the antenna array, hence a decision to replace the first antenna by another antenna of the array and have the latter functioning as the anchor antenna, may be taken at any time.

In accordance with another embodiment of the invention the first and/or second signal is transmitted to/from the anchor antenna via a wire (e.g. a cable network) and not via the air. Preferably, the method provided further comprises a step of determining whether to transmit any of the first and/or second signal via air or via that wire is carried out automatically based on at least one pre-defined criterion, e.g. depending on isolation between the various antennas and the anchor antenna. The term “carried out automatically”—as used herein should be understood to encompass cases where the calibration algorithm chooses (e.g. through the use of special switches) if the wire path should be added to the air path, as well as cases where an anchor antenna is chosen so that the signal transmitted from/to the anchor antenna never arrives to another antenna by wire-air “multi-path” that could result in the anti-phase interference.

According to another aspect of the invention there is provided a method for use in calibrating a plurality of antennas comprised in an antenna array and wherein the antenna array comprises at least one gain control circuitry. The method comprises:
transmitting one or more pre-defined signals by at least one antenna comprised in the antenna array;
receiving at one or more of the antennas comprised in the antenna array, a signal derived from a corresponding pre-defined signal transmitted by the at least one antenna; and
for each of the one or more antennas, detecting whether there is any difference between the corresponding one or more pre-defined signals transmitted thereto and the respective one or more signals received thereat, and if in the affirmative, applying the detected differences in a process of calibrating the one or more antennas comprised in the antenna array,
and wherein the process of calibrating the one or more antennas comprised in the antenna array comprises a step of estimating relative complex gains of transmit chains and receive chains associated with the antennas comprised in the antenna array.

Preferably, the step of estimating the relative complex gains of transmit chains and receive chains is carried out by transmitting pre-defined signal(s) via a plurality of transmit chains, wherein the number of transmit chains included in this plurality of transmit chains is less than the total number of transmit chains associated with the antennas comprised in the antenna array, and receiving the pre-defined signal(s) along a plurality of receive chains, wherein number of receive chains included in this plurality of receive chains is less than the total number of receive chains associated with the antennas comprised in the antenna array.

According to another embodiment of this aspect of the invention, the step of estimating is carried out a number of times, when each time the transmit chains and/or receive chains included in the plurality of transmit and/or receive chains are not equal to those included in the chains used for the previous estimation.

In accordance with another aspect of the present invention, there is provided a method for use in calibrating a plurality of antennas comprised in an antenna array and wherein the antenna array comprises at least one gain control circuitry. The method comprises:
setting the gain control circuitry according to a pre-defined calibration algorithm;
transmitting one or more pre-defined signals by at least one antenna comprised in the antenna array;
receiving at one or more of the antennas comprised in the antenna array, a signal derived from a corresponding pre-defined signal transmitted by the at least one antenna; and
for each of the one or more antennas, detecting whether there is any difference between the corresponding one or more pre-defined signals transmitted thereto and the respective one or more signals received thereat, and if in the affirmative, applying the detected differences in a process of calibrating the one or more antennas comprised in the antenna array.

According to another embodiment of this aspect of the invention, the method provided further comprising a step of dynamically changing the gain control circuitry at a calibration zone during transmitting/receiving one or more pre-defined signals.

By yet another embodiment, the method further comprising a step of estimating a ratio of complex transmission coefficients for at least two states of the at least one gain control circuitry. Preferably, the complex transmission coefficients comprise complex gain and/or complex coefficients for both gain/attenuation and phase.

According to yet another embodiment of the invention, the method provided further comprising a step of transmitting one or more pre-defined signals by at least two antenna comprised in the antenna array.

### BRIEF DESCRIPTION OF THE DRAWINGS

For a more complete understanding of the present invention, reference is made to the following detailed description taken in conjunction with the accompanying drawings wherein:

FIG. 1—presents one of the prior art solutions which relies on an external calibration unit;

FIG. 2—presents another prior art solution which uses a self calibration mechanism;

FIG. 3—presents an example demonstrating an embodiment for receiving the second signal derived from the transmission of the first signal by utilizing the reflecting effect in that antenna;

FIG. 4—presents an example of carrying out the RX calibration according to an embodiment of the present invention;

FIG. 5—presents an example of carrying out the TX calibration according to an embodiment of the present invention;

FIG. 6—presents an example of carrying out yet another embodiment of the present invention,

FIG. 7—illustrates a TX phase of calibration in an antenna array that comprises 4 units/antennas; and

FIG. 8—illustrates an RX phase of calibration in an antenna array that comprises 4 units/antennas.

### DETAILED DESCRIPTION OF THE INVENTION

A better understanding of the present invention is obtained when the following non-limiting detailed description is considered in conjunction with following figures.

As was previously explained, it is necessary to calibrate the amplitude and phase errors between the radio channels due to differences in the RF devices resulting from tolerances and operating frequencies in the antenna array. Since these errors tend to change over time e.g. due to temperature variations, real-time dynamic calibration is essential.

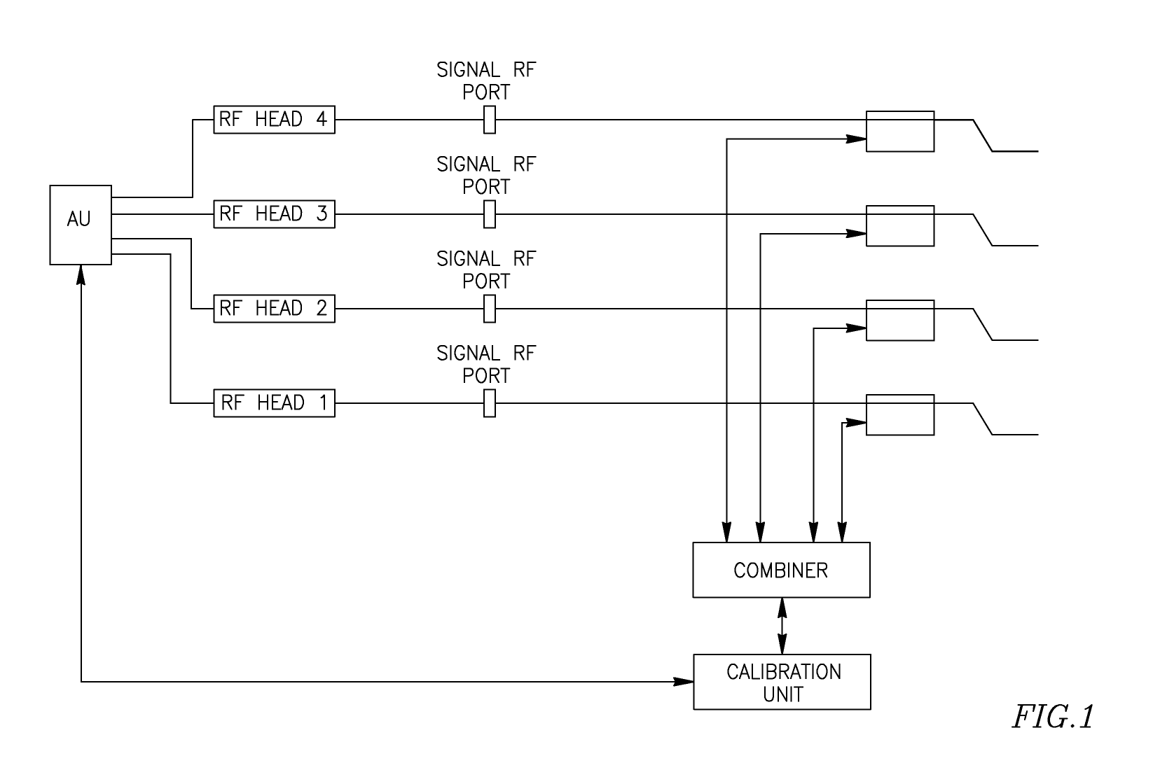

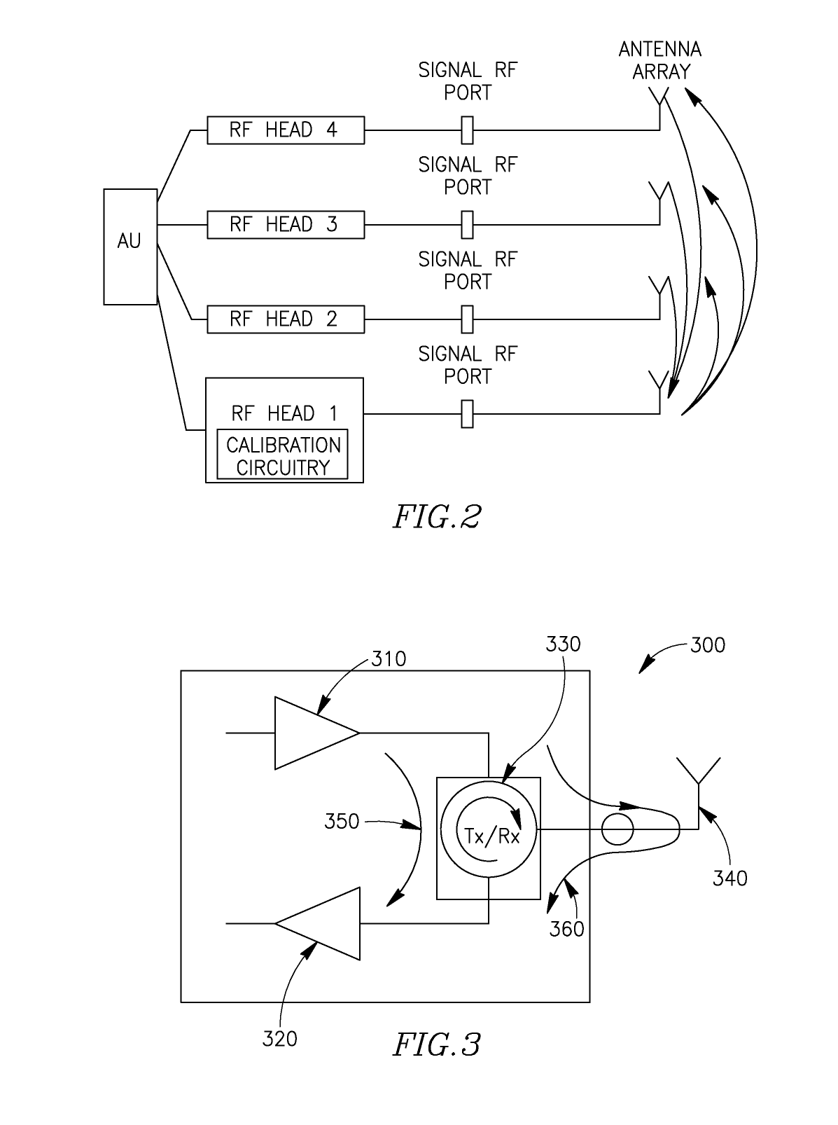

The commonly used methods today to cope with this need are the use of an external calibration unit as shown in FIG. 1 and the use of a self-calibration mechanism as demonstrated in FIG. 2.

As may be seen in FIG. 1, the major disadvantage of the external calibration scheme is that it requires additional radio unit with TX/RX calibration channels and additional control mechanisms to control and synchronize the calibration transmissions together with the regular modem transmissions. In addition, it requires also that the external circuitry would link the TX/RX channels with the calibration unit (e.g. by incorporating couplers and combiners into the antenna array design).

The example of a self-calibration scheme as demonstrated in FIG. 2 is based on the use of one or more of the TX/RX channels of the operative antennas for the purpose of self-calibration. Specifically, during the TX calibration, all the TX channels transmit the calibration signal while one or more of the RX channels are operative to receive it. After that, at RX stage of the calibration, all the RX channels receive while one or more of the TX channels transmit the calibration signal. The disadvantage of this method is that it uses a lot of additional components for the calibration, such as the switches to route the signal, couplers and combiners. This method requires special radio HW design and cannot be used on the basis of the existing design.

FIG. 3 is an example demonstrating an embodiment of the invention for receiving a signal (a second signal) that has been derived from the transmission of another (first) signal by utilizing the reflecting effect, in this case the non-ideality of the antenna which causes that effect. The apparatus (300) illustrated in this FIG. 3 comprises transmitter (310), receiver (320), TX/RX combining/separation block (330), e.g. a circulator, antenna (340) and two reflected signals. The first reflected signal (350) is derived from the TX/RX combining/separation block leakage due to the fact that when the calibration signal is transmitted it passes through TX/RX combining/separation block (330) but part of it finds its way back to receiver (320). The second reflected signal (360) is derived from the antenna's return loss (instead of being transmitted over the air).

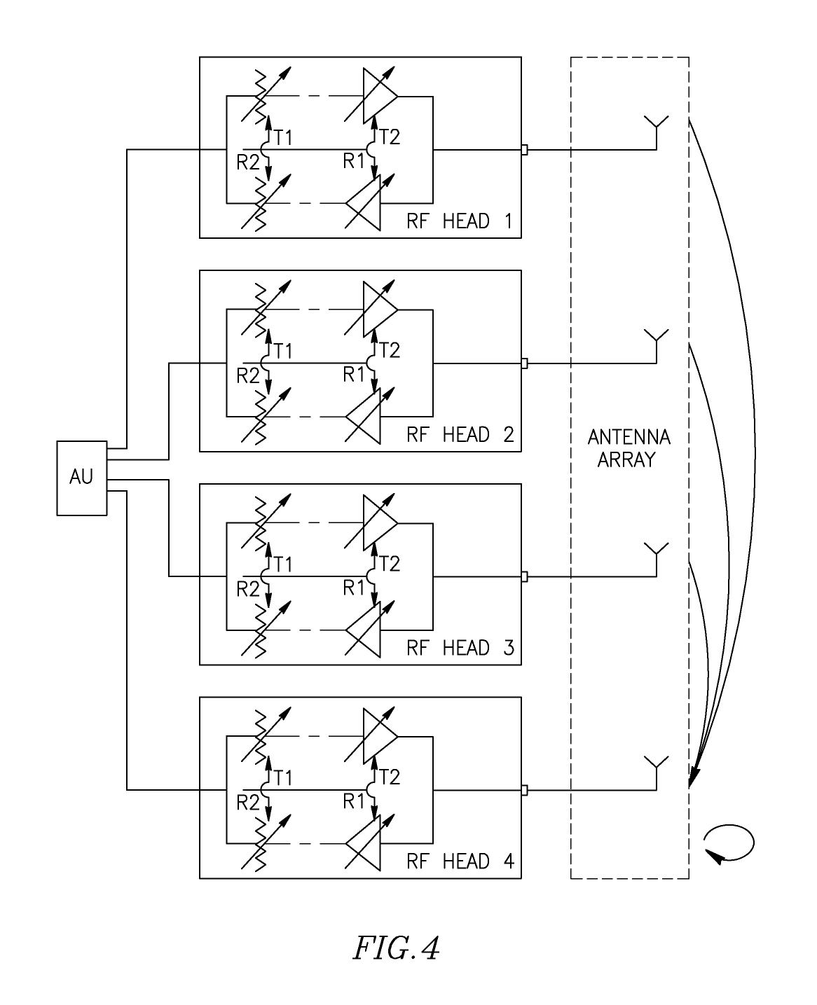

System (400) illustrated in FIG. 4 comprises four radio heads 410, 420, 430 and 440. In the system exemplified, radio head 410 is selected as an anchor radio head. During RX calibration, anchor radio head (410) transmits the calibration signal to four radio heads (i.e. including to itself). Thus, the signal is conveyed via all four RX paths while the receivers are set to a normal operational mode. For each of the four receivers, a processor is adapted to obtain at least one difference in the respective RF device resulting from tolerances and operating frequencies in the antenna array and determine how that respective RF device should be calibrated to compensate for the differences detected.

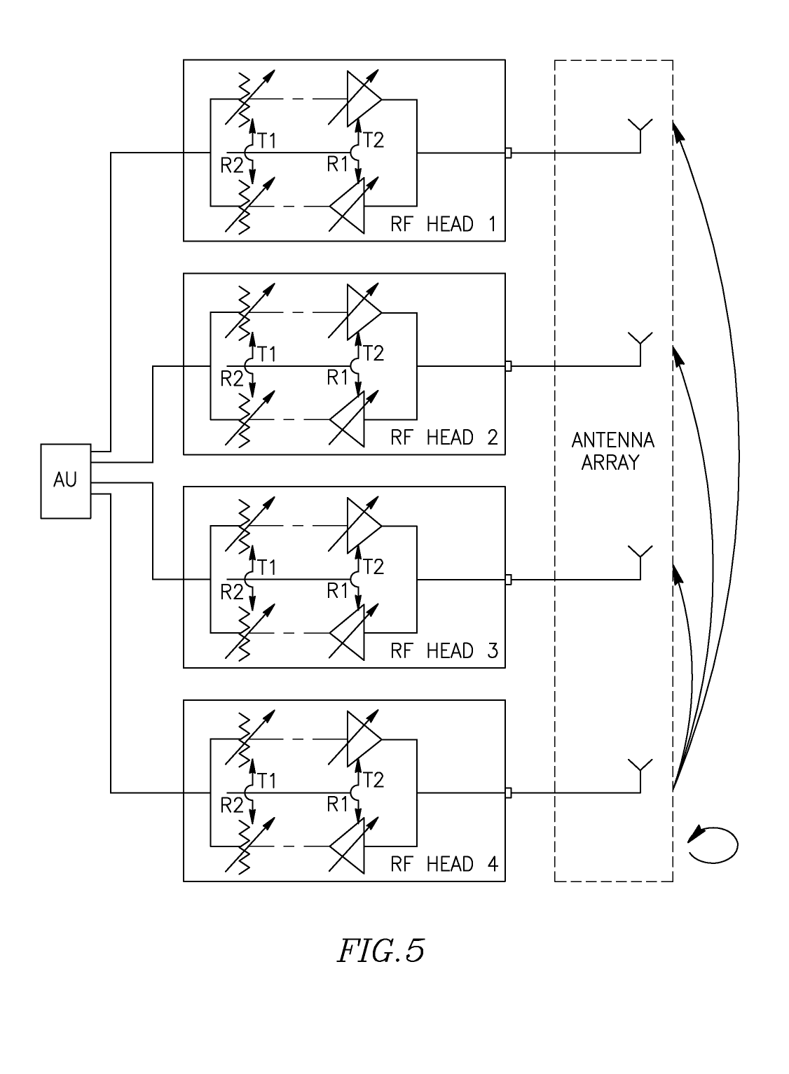

In system 500 illustrated in FIG. 5 there are four radio heads 510, 520, 530 and 540. In this example, radio head 510 is selected as the anchor radio head. During the TX calibration all radio heads (510, 520, 530 and 540) transmit the calibration signals towards the anchor radio head (510) either one at a time or simultaneously. The signals which can be the same signal for all radio heads or different ones (at least for some of the radio heads) are conveyed along all four TX paths while the respective channels are set to a normal operational mode.

As will be appreciated by those skilled in the art, the preferred calibration scheme will be a combination of both the RX calibration and the TX calibration.

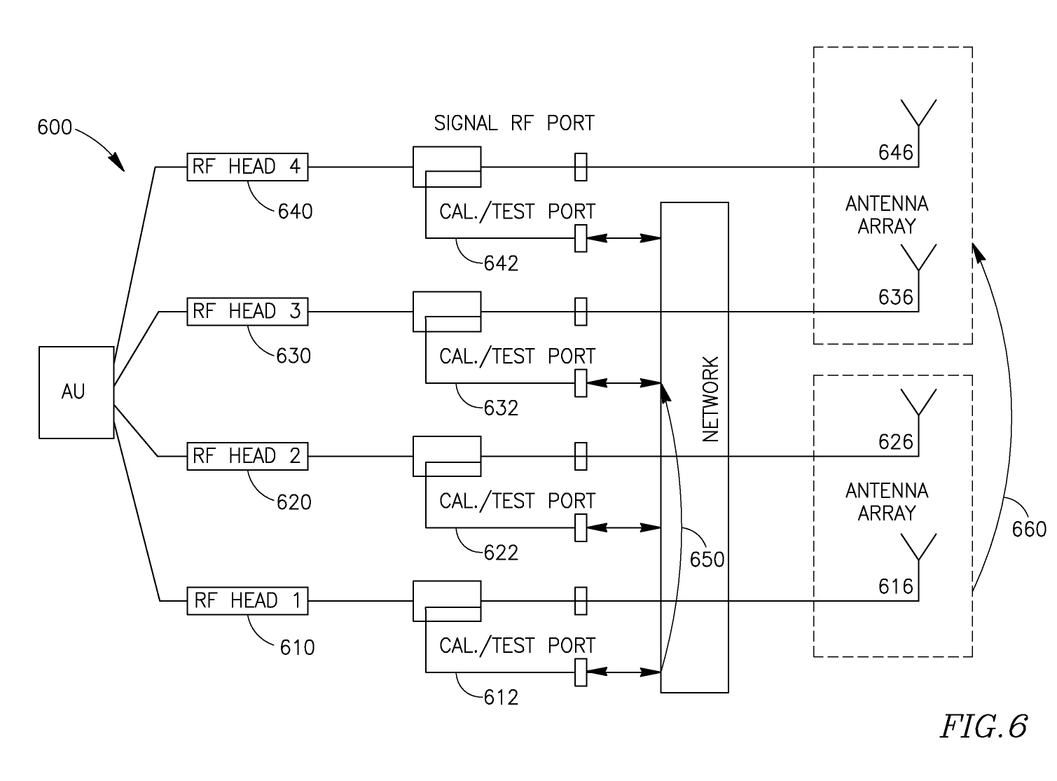

In system 600 illustrated in FIG. 6 there are four radio heads 610, 620, 630 and 640. Each of the radio heads comprises four signal RF port 612, 622, 632 and 642 respectively, and four antennas 616, 626, 636 and 646, respectively. The two arrows (650, 660) indicate two signal transmissions options. The option of internal transmission (650), is carried out by transmitting the signal via cables (e.g. within the network), whereas the option of external transmission (660) is materialized through the antennas and via the air. Although that from a practical point of view the system of the present invention is independent of the path along which the signal is transmitted, still according to an embodiment of the invention system (600) is optionally capable of determining automatically which path would be better to transmit the calibration signal, e.g. depending on the isolation between the various antennas and the anchor antenna, and to transmit it accordingly. Such an automatic determination may be carried out as explained above either by having the calibration algorithm choosing if the wire path should be added to the air path, or by choosing an anchor antenna so that the signal transmitted from/to the anchor antenna never arrives to another antenna by wire-air “multi-path”.

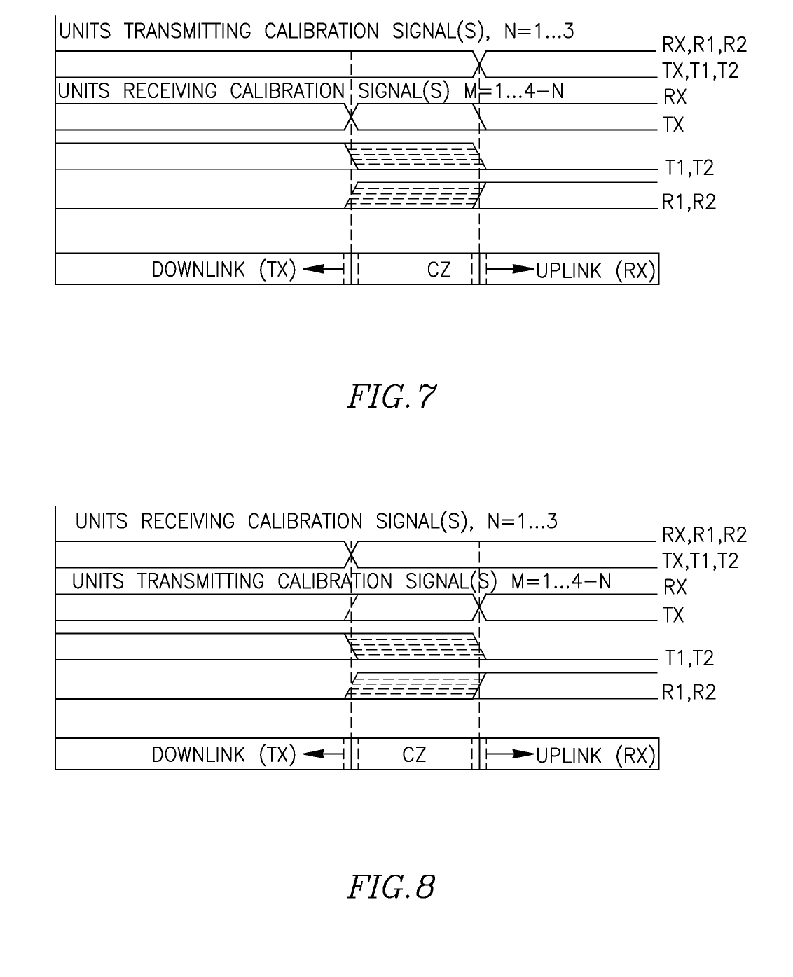

FIGS. 7 and 8 illustrate a TX phase and an RX phase, respectively, of calibration in an antenna array that comprises 4 units/antennas. The time period used for calibrating antenna array according to the present invention is only a short period/slot in a calibration frame. In these FIGs., the transmit/receive paths include gain control circuitry, capable of changing its state dynamically while entering the calibration phase (calibration zone) and while exiting same, according to a pre-defined calibration algorithm. The current state of the gain control circuitry is derived based on losses incurred along the path connecting the various elements in the respective transmit/receive chain(s).

Following are few examples of self calibration schemes.

### Scheme 1

This self calibration scheme is divided into two phases. The first phase, RX calibration phase, utilizes one of the radio heads (the anchor radio head) for transmitting while the rest of the radio heads are receiving. In the next phase, TX calibration phase, utilizes the same anchor radio head for receiving while transmitting is done from the rest of the radio heads. For K radio heads there are to handle 2*(K−1) measurements.

Specifically, for two radio heads (k=1,2), there are 2 measurements. In this case the scheme is indifferent to choosing the anchor radio head and each of the two measurements may either be considered as the RX calibration phase or the TX calibration phase.

RX (or TX) calibration phase:
H¹²=TX¹RX²C¹²
   TX (or RX) calibration phase:
H²¹TX²RX¹C²¹

From the above measurements, factored ratio between the RX and TX paths for all the radio heads can be calculated:

$$Cal\_Vec = [ 1 , \frac{{H}^{21}}{{H}^{12}} ] = [ 1 , \frac{{TX}^{2} {RX}^{1}}{{TX}^{1} {RX}^{2}} ] = \frac{{RX}^{1}}{{TX}^{1}} [ \frac{{TX}^{1}}{{RX}^{1}} , \frac{{TX}^{2}}{{RX}^{2}} ]$$

$${Cal\_Vec}_{k} = factor \cdot [ \frac{{TX}^{k}}{{RX}^{k}} ]$$

$$k = 1 , 2$$

TX^{k}—Frequency response of transmit path of radio head k
RX^{k}—Frequency response of receive path of radio head k
C^{kl}=C^{lk}—Reciprocal frequency response between transmit/receive path k and receive/transmit path 1.

For four radio heads (k=1,2,3,4), there are 2 phases of 3 measurements each total of 6 measurements over three different pairs. Assume radio head #1 is the anchor radio head:

RX calibration phase:
H¹²=TX¹RX²C¹²
H¹³=TX¹RX³C¹³
H¹⁴=TX¹RX⁴C¹⁴
   TX calibration phase:
H²¹=TX²RX¹C²¹
H³¹=TX³RX¹C³¹
H⁴¹=TX⁴RX¹C⁴¹

From the above measurements, a factored ratio between the RX and TX paths for all the radio heads can be calculated:

$$Cal\_Vec = [ 1 , \frac{{H}^{21}}{{H}^{12}} , \frac{{H}^{31}}{{H}^{13}} , \frac{{H}^{41}}{{H}^{14}} ] = \frac{{RX}^{1}}{{TX}^{1}} [ \frac{{TX}^{1}}{{RX}^{1}} , \frac{{TX}^{2}}{{RX}^{2}} , \frac{{TX}^{3}}{{RX}^{3}} , \frac{{TX}^{4}}{{RX}^{4}} ]$$

$${Cal\_Vec}_{k} = factor \cdot [ \frac{{TX}^{k}}{{RX}^{k}} ]$$

$$k = 1 , 2 , 3 , 4$$

Here, the step of selecting first antenna from among the plurality of antennas can be based upon evaluating the set of measured pairs (1 [symbol] 2, 1 [symbol] 3 and 1 [symbol] 4 in this example) resulting with best quality in terms of, for example, signal to noise and interference ratio (SINR) at receiving antenna port. Thus, one can avoid measuring a pair which results with low quality. For example, one can choose radio head #2 as the anchor radio head resulting the measured pairs to be (2 [symbol] 1, 2 [symbol] 3 and 2 [symbol] 4) thus avoiding 15 measuring the (1 [symbol] 3, 1 [symbol] 4 and 3 [symbol] 4) pairs.

### Scheme 2

In this scheme, four radio heads are taken as an example, enabling another level of freedom in avoiding measurements of specific pairs while using two anchor radio heads.

The first phase, RX calibration, utilizes one of the anchor radio heads (#1 in this example) for transmitting while two other non-anchor (#3 and #4 in this example) radio heads are receiving. Also as part of the RX calibration phase, the other anchor radio head (#2 in this example) is used for transmitting while only one of the non-anchored (#3 in this example) radio heads is receiving. The second phase, TX calibration, utilizes one of the anchor radio heads (#1 in this example) for receiving while two other non-anchor (#3 and #4 in this example) radio heads are transmitting. Also as part of the RX calibration phase, the other anchor radio head (#2 in this example) is used for receiving while only one of the non-anchor (#3 in this example) radio heads is transmitting. For K radio heads there are 2*(K−1) measurements.

In this example, 1 [symbol] 2 and 3 [symbol] 4 measurements are avoided.

RX calibration phase:
H¹³=TX¹R³C¹³
H¹⁴=TX¹RX⁴C¹⁴
H²³TX²RX³C²³
   TX calibration phase:
H^{31 =TX}³RX¹C³¹
H⁴¹=TX⁴RX¹C⁴¹
H³²=TX³RX²C³²

From the above measurements, a factored ratio between the RX and TX paths for all the radio heads can be calculated:

$$Vec = [ 1 , \frac{{H}^{23} {H}^{31}}{{H}^{13} {H}^{32}} , \frac{{H}^{31}}{{H}^{13}} , \frac{{H}^{41}}{{H}^{14}} ] = \frac{{RX}^{1}}{{TX}^{1}} [ \frac{{TX}^{1}}{{RX}^{1}} , \frac{{TX}^{2}}{{RX}^{2}} , \frac{{TX}^{3}}{{RX}^{3}} , \frac{{TX}^{4}}{{RX}^{4}} ]$$

$${Cal\_Vec}_{k} = factor \cdot [ \frac{{TX}^{k}}{{RX}^{k}} ]$$

$$k = 1 , 2 , 3 , 4$$

It is to be understood that the above description only includes some embodiments of the invention and serves for its illustration. Numerous other ways of carrying out self testing and/or calibration of antennas in an antenna array in wireless telecommunication networks may be devised by a person skilled in the art without departing from the scope of the invention, and are thus encompassed by the present invention. For example, it should be clear to any person skilled in the art that the signal transmitted from the anchor antenna towards the other antennas in the array could be the same signal as it transmits for its self-calibration, or can be a different signal. Similarly, the pre-defined signals transmitted by each of the antennas while calibrating the TX channels could be the same signals or different signals. Also, shifting the functionality from one device to another device within the systems described is encompassed by the present invention.

The present invention has been described using non-limiting detailed descriptions of preferred embodiments thereof that are provided by way of example and are not intended to limit the scope of the invention. It should be understood that features described with respect to one embodiment may be used with other embodiments. Variations of embodiments described will occur to persons of the art. Furthermore, the terms “comprise”, “include”, “have” and their conjugates shall mean, when used in the claims “including but not necessarily limited to”. Also when term was used in the singular form it should be understood to encompass its plural form and vice versa, as the case may be.

1. A method for use in calibrating a plurality of antennas comprised in an antenna array and wherein said antenna array comprises at least one gain control circuitry, said method comprises:
transmitting one or more pre-defined signals by at least one antenna comprised in said antenna array;
receiving at one or more of the antennas comprised in the antenna array, a signal derived from a corresponding pre-defined signal transmitted by the at least one antenna; and
for each of the one or more antennas, detecting whether there is any difference between the corresponding one or more pre-defined signals transmitted thereto and the respective one or more signals received thereat, and if in the affirmative, applying the detected differences in a process of calibrating said one or more antennas comprised in the antenna array,
and wherein the process of calibrating said one or more antennas comprised in the antenna array comprises a step of estimating a ratio of complex transmission coefficients for at least two states of said at least one gain control circuitry.

2. A method according to claim 1, further comprising a step of selecting an antenna from among the plurality of antennas comprised in the antenna array for transmitting the one or more pre-defined signals which would enable achieving improved overall calibration of said antenna array.

3. A method according to claim 1, wherein said process of calibrating said one or more antennas comprised in the antenna array, is a dynamic process adapted to be carried out at the antenna array installation site.

4. A method according to claim 1, further comprising a step of determining whether any of said pre-defined signals and/or their corresponding receive signals are to be conveyed along a path extending between at least two antennas comprised in said antenna array via a cable.

5. A method for use in calibrating a plurality of antennas comprised in an antenna array and wherein said antenna array comprises at least one gain control circuitry, said method comprises:
setting said gain control circuitry according to a pre-defined calibration algorithm;
transmitting one or more pre-defined signals by at least one antenna comprised in said antenna array;
receiving at one or more of the antennas comprised in the antenna array, a signal derived from a corresponding pre-defined signal transmitted by the at least one antenna; and
for each of the one or more antennas, detecting whether there is any difference between the corresponding one or more pre-defined signals transmitted thereto and the respective one or more signals received thereat, and if in the affirmative, applying the detected differences in a process of calibrating said one or more antennas comprised in the antenna array.

6. A method according to claim 5, further comprising a step of dynamically changing said gain control circuitry at a calibration zone during transmitting/receiving one or more pre-defined signals.

7. A method according to claim 5, further comprising a step of estimating a ratio of complex transmission coefficients for at least two states of said at least one gain control circuitry.

8. A method according to claim 7, wherein said complex transmission coefficients comprise complex gain and/or complex coefficients for gain/attenuation and phase.

9. A method according to claim 5, further comprising a step of transmitting one or more pre-defined signals by at least two antenna comprised in said antenna array.
